(19) United States
(12) Patent Application Publication
(10) Pub. No.: US 2005/0182229 A1
(43) Pub. Date: Aug. 18, 2005

(54) Process for incorporating substances into polymeric materials in a controllable manner

(76) Inventor: Jean-Pierre Ibar, Wallingford, CT (US)

Correspondence Address: LAURENCE T. PEARSON, 2009 DOGWOOD LANE, WILMINGTON, DE, 19810, US

(21) Appl. No.: 11/059,880

(22) Filed: Feb. 17, 2005

Related U.S. Application Data
(63) Continuation-in-part of application No. 10/781,981, filed on Feb. 18, 2004, now abandoned.
(63) Continuation-in-part of application No. 10/781,982, filed on Feb. 18, 2004, now abandoned.

(51) Int. Cl. C08G 64/00

(52) U.S. Cl. 528/196

(57) ABSTRACT

A method for controlling the molecular weight and other properties of a polymer by permeating it with a small molecule while the polymer is in the solid state and optionally subjecting the polymer plus permeant blend to a melt processing operation. The polymer is optionally in a molecularly disentangled state.

### PRIOR APPLICATION DATA

This application is a CIP of application Ser. Nos. 10/781,981 and 10/781,982 both filed on 17 Feb. 2004.

### FIELD OF THE INVENTION

This invention pertains to processes for controlling the molecular weight and fluidity of polymer melts by incorporating into the solid polymer, materials in the form of gases, liquids, mists, and their blends. The invention also pertains to the products made thereby. The invention also pertains to modifying properties of the solid polymer by introduction of substances while the polymer is in a molecularly disentangled state.

### BACKGROUND

Polymers are made up of long chain molecules, i.e. macromolecules, which entangle themselves, The entanglement provides mechanical strength to the polymer in the solid and melt phases, but also increases the viscosity of the melt phase. Higher polymer chain molecular weight in general results in higher viscosity, and therefore a higher power requirement for processing a given polymer at a given temperature.

Control of molecular weight, and hence the viscosity and solid phase physical properties of a polymer, has long been a goal of many processors. Polymer chains can be lengthened by the addition of cross linking agents, or by post polymerization in the melt phase of a reactor made prepolymer. This technology is described and exemplified in U.S. Pat. No. 6,657,039 to LG Chemical, in which polycarbonate is subjected to a treatment like this.

An approach to molecular weight reduction that has become common is the controlled degradation of the polymer chains using a chain breaking agent. Peroxides are commonly used for this purpose, and U.S. Pat. No. 5,530,073 to Amoco describes the use of 2,5-dimethyl-2,5-bis(t-butylperoxy)hexane with polypropylene. Another example is U.S. Pat. No. 6,620,892 to Atofina in which is disclosed a process for production of a controlled-rheology resin, the process comprising adding at least one stable free radical to a resin containing a propylene homopolymer or copolymer, whereby said process increase the fluidity index of the resin by cuts of the chains, and a solid product that has an increased fluidity index is formed. Other references in the patent art to this technology include WO-A-96/12753; EP-A-570 812; U.S. Pat. No. 5,932,660; JP-A-07/138,320; U.S. Pat. No. 5,530,073; WO-A-96/06872; U.S. Pat. No. 5,705,568; U.S. Pat. No. 3,862,265; U.S. Pat. No. 5,945,492; CA-A-2 258 305; U.S. Pat. No. 4,900,781; DE-A-1 694 563; U.S. Pat. No. 4,672,088; and EP-A-0 853 090.

There are many other examples in the prior art of this approach with polyolefins, for a recent review see for example D. Munteanu, in “Plastics Additives, 5^{th} Edition, ed. H. Zweifel, chapter 14, Hanser Pubishers, Munich.

A major limitation of this approach to controlling the molecular weight of polymers is that molecular weight and fluidity, as measured by viscosity, are linked, and the benefits obtained by changing one can be offset by the disadvantages caused by the change that necessarily takes place in the other. For example, superior physical properties in the solid phase as obtained from higher molecular weight, are offset by higher processing costs due to higher power requirements.

Some of these disadvantages are overcome in U.S. Pat. Nos. 5,885,495 and 6,210,030 issued to the present inventor, respectively describe a process and an apparatus capable of controlling the viscosity of polymeric materials by disentanglement of the molecular chains of which the polymer is comprised. However the industry would like to see a process for reducing the viscosity of polymers even further, with substantially no loss in molecular weight and hence no loss in desirable physical properties. The present invention is directed towards production of polymers that have greatly enhanced ease of processing through viscosity reduction and increased permeability to substances such as fluids.

The present invention also has utility, for example, in systems that use the permeability of materials to deliver substances, for example to the human skin.

### BRIEF SUMMARY OF THE INVENTION

The present inventor has now unexpectedly found that it is possible to further control the viscosity and molecular weight of polymers by incorporating additives into the polymer in the solid phase, in such a way that the additives have been permeated into the polymer and become in intimate contact with the polymer chains. Some of the additives that would be expected to be inert with respect to the chemical structure of the chains still have the desired effect.

The present invention provides a process to incorporate into polymeric materials that are optionally molecularly disentangled, at a temperature below the solidification temperature of the polymer, and preferably when the resin is still in the form of pellets or granules, and under controlled conditions of temperature and pressure, amounts of other molecules (“the permeating material” or “permeant”) whose presence inside the polymer is able to affect its future behavior and properties.

The physical form of the material to be inserted into the free volume of the polymer can be a simple gas, a vapor, a fluidized bed or an aerosol or a mixture of any of these. The material can also be in the form of a liquid from which molecules can diffuse, such as a mist or a bulk liquid, or an emulsion. The material can also be in the form of a solid, preferably a finely divided solid, in which molecules diffuse from a solid that is in contact with the polymer surface. Examples of solid phase materials are bulk materials, or particles in suspension, including nanoparticles,

After controlled exposure to the permeating material, and return to storage conditions, generally room temperature and atmospheric pressure, the free volume of the polymer is now occupied with molecules from that substance, and their presence in the structure may result in a modification of the polymer characteristics, either in the solid state, or in the molten state.

A suitable means for disentangling polymer is disclosed in U.S. Pat. No. 5,885,495 to Ibar, that teaches a process to disentangle the macromolecules of a polymer melt by a method that combines pure shear deformation, by drag or pressure flow, shear vibration and melt fatigue under extensional flow, such that the viscosity of the melt can be significantly reduced by the compounded effect of pure shear and shear vibration on shear-thinning, and the shear oscillation strain amplitude. U.S. Pat. No. 6,210,030, also to Ibar, describes a novel apparatus and methods to apply industrially the disentanglement process taught in U.S. Pat. No. 5,885,495.

In a preferred embodiment of the invention, the permeating material is added to disentangled polymer pellets as the pellets are being fed into processing equipment. In a non limiting example, disentangled pellets are dried under vacuum, fed into the hopper of an extruder, where the permeating material is also introduced. Permeation of the substance into the polymer pellets then takes place in the extruder hopper, and the intimate mixture of polymer plus permeating material are then extruded together.

In another embodiment of the present invention, pellets of disentangled polymers are inoculated with a dosed amount of chemical molecules able to react, at processing temperature, with the bonds of the macromolecules embedded in the free volume, and break the chain into two or more segments or create branching and/or cross-linking, thus modifying the molecular weight distribution of the polymer. In a further example of an embodiment of the present invention, the small concentration of permeating material molecules occupying the free volume can be used to characterize the type of polymer that the polymer matrix comprises. For example for the purpose of sorting automatically recycled plastics, or to characterize the identity of the molder of the part manufactured from the products made with the present invention.

In another embodiment of the invention, the molecules of the substance incorporated in the free volume are ionized or are ions. The effect is to modify the dielectric properties of the polymer product treated, and the surface and bulk conductivity.

In another embodiment of the invention, the molecules of the substance incorporated in the free volume are magnetically polarized or are magnets. The effect is to modify the magnetic properties of the polymer product treated.

In another embodiment of the present invention, the barrier properties of the products created hereby are improved, by the incorporation and remaining presence of specific particles, for instance nanoparticles, which plug up the free volume pathways mostly responsible for gas and liquid diffusion.

In another embodiment of the present invention, pellets of disentangled polymers are inoculated with a dosed amount of chemical molecules able to react, at processing temperature, with the bonds of the macromolecules embedded in the free volume, and break the chain into two or more segments, thus modifying the molecular weight distribution of the polymer.

In yet another embodiment of the invention, polymer in a solid phase is permeated with a substance while the polymer is in a non disentangled state and subjected to a meting and processing operation that modifies it rheological properties.

### BRIEF DESCRIPTION OF THE FIGURES

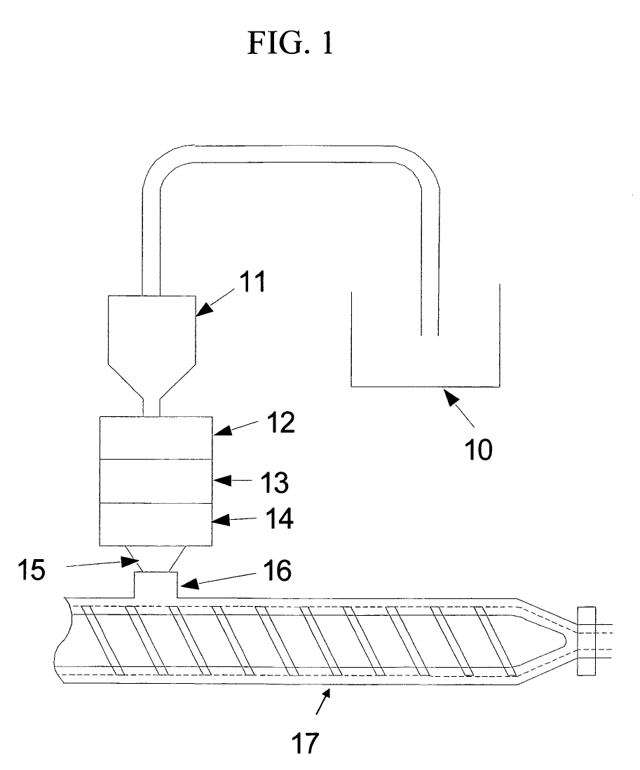

In FIG. 1 is shown a schematic diagram of an apparatus that can carry out the process of the present invention in that a supply of polymer pellets is dosed with a permeant before being melt processed.

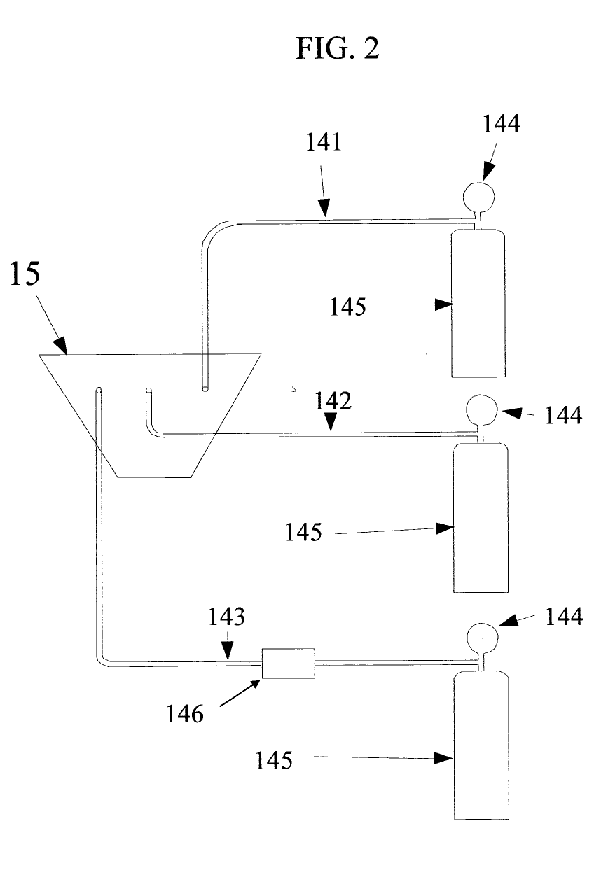

In FIG. 2 is shown a design for a manifold of which the equipment of FIG. 1 comprises.

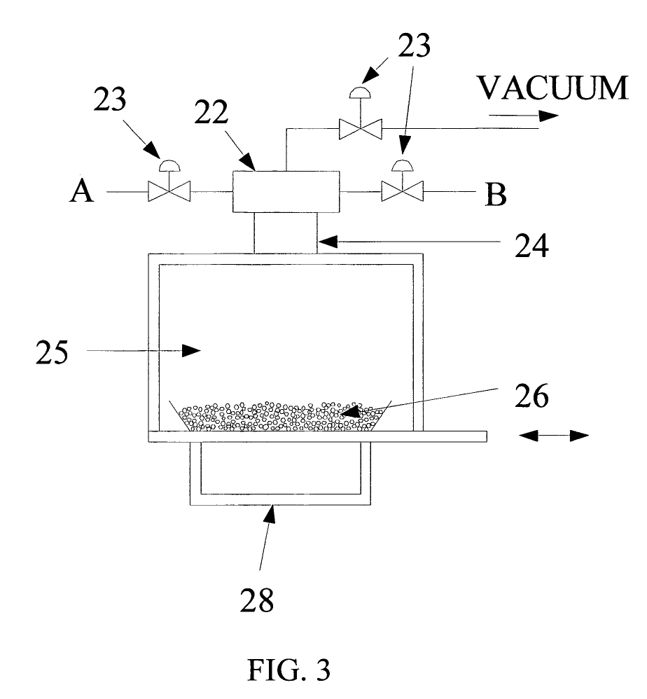

In FIG. 3 is shown a design for a dosing chamber suitable for use in the process of the present invention.

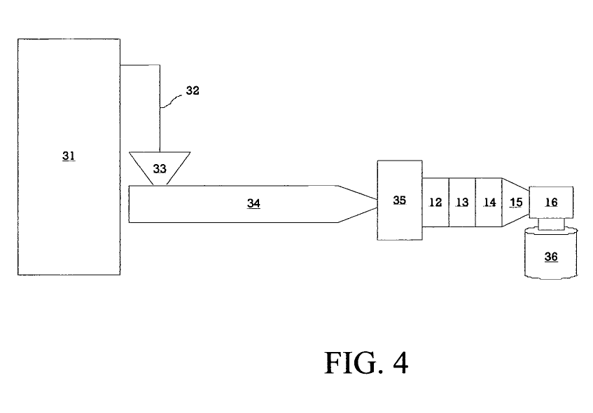

In FIG. 4 is shown a further embodiment of the invention, in which product from a polymerization reactor is extruded, disentangled, pelletized, and then dosed with permeant.

### DETAILED DESCRIPTION OF THE INVENTION

### Definitions

The invention can be best understood by reference to the following definitions.

By “polymer chain” is meant the molecular backbone of the polymer. In a linear polymer, the backbone comprises the longest sequence of connected atoms in any given molecule. In a highly branched polymer such as low density polyethylene (LDPE), the backbone comprises all of the carbon atoms in a given molecule.

The terms “polymer” and “polymeric material” as used herein are synonymous, and are defined as in the Handbook of Chemistry and Physics, 84^{th} Edition CRC Press, 2003-2004, page 13-7 to 13-14, which pages are hereby incorporated herein by reference.

The term “disentangled” as used in the context of polymers, refers to polymer pellets or products produced by “disentanglement”, which refers to the process of either partially or completely removing entanglements among polymer chains in a given polymer sample. Both U.S. Pat. No. 5,885,495 and U.S. Pat. No. 6,210,030, and both to Ibar and both incorporated herein by reference in their entirety, disclose use of disentanglement to control, and essentially lower, the viscosity on a polymer melt. These patents also disclose the disentanglement processing window parameters which optimize the efficiency of the viscosity control invention.

The preferred means for disentangling uses the “Tek Flow Processor”, which refers to a commercial apparatus of the embodiment of the invention of U.S. Pat. No. 6,210,030 in which the viscosity of a polymer is controlled by disentanglement of the polymer chains that the polymer comprises. The Tek Flow Processor is available from Stratek Plastic Ltd. (Dublin, Ireland).

By the term “essentially zero” when used to describe the disentanglement state is menat that a polymer has not been through a means for disentanglement.

By “drying” is meant the process by which heat and, optionally vacuum, to remove moisture from a polymer. An example apparatus combining heat and vacuum means to remove water molecules from a polymer pellet or product is commercially available from the Maguire Corporation (Pennsylvania, USA), however, many commercial driers in many configurations are available to, and would be known by, one skilled in the art. It is to be understood that the dried polymer that is obtained from a drying step does not necessarily have zero moisture content, but rather is to be understood as having sufficient moisture that the polymer can be passed to the subsequent processing steps of the invention, with whatever residual moisture in the sample not causing any loss in efficacy of the process.

By “permeant” is meant a substance that enters the free volume of a solid polymer. The permeant can be in the form of a liquid, gas, plasma or solid.

The term “gas mixture” refers to the product obtained by mixing two or more gases or volatiles in a chamber, at a temperature, pressure and under concentration conditions which allow the mixture to be transferable to a vacuum chamber holding the pellets or the parts to be treated according to the present invention. For instance, gas mixture can combine an inert gas and a chemical volatile, in a given proportion. The gas may be ionized or one of its components may be ionized by plasma or high voltage discharge.

The term “plasma” refers to the state of matter obtained by subjecting a gas to an electrical discharge. A plasma generally comprises species such as ions and atoms that are not generally available in states of matter that are available outside of the discharge.

By “temperature of solidification” is meant that temperature of a polymer, copolymer or polymer blend, below which the material presents the mechanical characteristics of a solid.

By “polymer pellets” is meant the resin products usually produced in reactors, and stocked in bags at room temperature, or a temperature below their temperature of solidification, under either pellets, granular, chips or powder (fluff) form.

By “means for forming” is meant a process by which a polymer melt is turned into a useful article. Forming means are well known to those skilled in the art and include, but are not limited to for the purposes of this disclosure, injection molding, blow molding, film extrusion, sheet extrusion, extrusion to form tapes or fibers, or tubes, and rotomolding.

The “% chain scission” of a polymer sample is defined herein with respect to a reference material by the formula;
% chain scission=100(1−M_{w}/M_{wref})
where M_{w} is the weight average molecular weight of the polymer sample, and M_{wref} is the weight average molecular weight of a control sample, normally the polymer chains before scission.

The “degree of disentanglement” is a measure of the change in melt flow index (MFI) of a virgin, or disentangled resin upon being subjected to a process of the invention, corrected for any change in molecular weight that the polymer chains may have undergone.

The formula for degree of disentanglement is given by:

$$Degree of Disentanglement = 100 [ \frac{{MFI}_{final}}{{{MFI}_{initial} ( \frac{{Mw}_{initial}}{{Mw}_{final}} )}^{3.4}} - 1 ]$$

For example, if a virgin polymer of MFI=10.0 and Mw of 25,000 is subjected to the process of the invention and is transformed to a MFI of 250 and a Mw of 22,000. The degree of disentanglement of the final polymer is then;

$$100 \times [ ( 250 / 15.44 ) - 1 ] = 1519 \%$$

A virgin resin therefore, by definition, has a degree of disentanglement of zero. However, a resin that has been subjected to pure chain scission also has a degree of disentanglement of zero, if the MFI is still following a dependence on M_{w}^{-3.4}, and
MFI_{final}=MFIᵢₙᵢₜᵢₐₗ*(M_{w ini}/M_{w final})^{3.4}

### DESCRIPTION OF THE PREFERRED EMBODIMENTS

The method of the present invention comprises the steps of providing a solid polymer, preferably in the form of solid pellets, and that are optionally in a molecularly disentangled state greater than about 2%, and drying the polymer under controlled conditions of temperature and humidity. The polymer should be dried to an effective level of moisture that allows permeant to enter the polymer solid. Such an effective level will generally be below 1% by weight, and preferably less than 0.5% by weight and more preferably less than 0.1% by weight. The method further comprises the steps of exposing the dried polymer to a permeant and allowing the permeant to permeate the solid polymer. In one embodiment of the invention a change in the molecular weight or the molecular disentanglement state of the polymer is produced by an optional subsequent melt processing step, or, in another embodiment of the invention, to disperse the permeant and polymer blend and affect the properties of the product or article once molded.

In the optional melt processing step, in which the blend is subjected to a combination of temperature, pressure, and shear, and which allow the components of the blend to react with each other, a change in the molecular weight or the molecular disentanglement state of the polymer is produced.

The conditions for each step in the process can be determined by a minimal level of experimentation, in which the final polymer characteristics are mapped as a function of the parameters of the process, such as temperatures, pressures, shear rate etc. The present inventor has discovered that many types of permeant can be used to effect changes in many polymers. For example, antioxidants such as phenols, amines, phosphites and sulfur containing stabilizers. Also UV Stabilizers such as hindered amine light stabilizers. More specifically, alkylphenols, hydroxyphenylpropionates, hydroxybenzyl compounds, alkylidene bisphenols, secondary aromatic amines, thiobisphenols, aminopheonols, thiothers, phosphates and phosphonites and sterically hindred amine. Also metal deactivators, amides of aliphatic and aromatic mono and dicarboxylic acids and their N-monosubstituted derivatives such as for example N,N′ diphenyl oxamide,

Also permeants such as cyclic amides such as barbituric acid, hydrazones and bishydrazones of aliphatic and aromatic aldehydes, as benzaldehyde and salicylaldehyde or of o-hydroxy-aryl-ketones. Also, bis acylated hydrazine derivatives, heterocylic compounds, for example melamine, benzotriazoles, 8-oxyquinoline, hydrazones and acylated derivatives of hydrazinotriazines, aminotriazaoles an acylated derivatives thereof.

Also polyhydrazides, molecular combinations of sterically hindered phenols and metal complexing groups, nickel salts of benzyl phosphonic acids, alone, or in combination with other antioxidants or metal deactivators, pyridenethiol tin compounds and phosphorous acid esters of a thiobisphenol.

Solvents for the specific polymer system can also be used. A solvent for a polymer. When used herein, a solvent for the polymer is as defined in the Handbook of Chemistry and Physics, 84^{th} Edition CRC Press, 2003-2004, page 13-6, which is hereby incorporated herein by reference. For example, toluene, xylene, halogenated benzenes such as dichloro- and trichlorobenzene can be used for polyolefins. Aromatic or aliphatic hydrocarbons, alcohols, or esters are also suitable permeants for use in the invention.

Suitable permeants for use in the invention are also chlorofluorocarbons as described in the Handbook of Chemistry and Physics, 84^{th} Edition CRC Press, 2003-2004, page 6-144 to 6-146, which pages are hereby incorporated herein by reference.

Further examples of suitable permeants for use in the invention are acetic acid, azobisisobutyronitrile, benzoyl peroxide, dicumyl peroxide, glycolic acid, stearic acid, maleic acid, tannic acid, sebacic acid, adipic acid, caprylic acid, salicyclic acid, 1-octanol, 2-ethylhexanol, polyethylene glycol, resorcinol, pentaerythritol, di-pentaerythritol, saccharose, glycerin, and any trihydric alcohol or diol.

Still further examples of suitable permeants for use in the invention are pentaerythritol esters of fatty acids such as stearic acid, oleic acid, glycerol rosin ester, esters of propionic acid, butyric acid, tetraesters of caproic and peralgonic acids. Also included are esters of monobasic long chain fatty acids, for example stearic, palmitic acid, and myristic acid and esters of pentaerythritol, polyol esters and esters of dicarboxylic acids such as maleic acid.

Also included are fatty alcohols, such as lauryl, cetyl, stearyl, oleyl alcohols, glycerol stearate, glycerol monolaurate, glyceryl hydroxystearate, ricinolate esters, caprylic triglycerides, capric triglycerides and methyl acetyl ricinoleate.

The scope and claims of the invention are not, however, intended to be limited by the above list, and any permeant that is effective in modifying the polymer is suitable for use in the invention.

The permeant can also be a material that labels in some way the polymer for future identification. Examples of permeants that work in this manner include fluorescent materials, phosphorescent materials, paramagnetic materials such as spin labels, materials that have a characteristic infrared band that can be used to characterize their presence, and molecules in general that can be characterized spectroscopically while in the polymer matrix.

The permeant can also be a material that modifies the dielectric or magnetic properties of the polymer in some way, For example ionic compounds or materials that are magnetized.

The method of the invention can be further understood by reference to the figures. In FIG. 1 is shown a schematic diagram of an embodiment of the process of the invention in which disentangled polymer pellets are supplied from a Gaylord container (10) via a vacuum hose to a loading device (11). In a typical embodiment, the loading device will be a gravimetric feeder, as supplied for example by K-Tron (of Pitman, N.J.), that supplies pellets at a controlled rate or in controlled batch weights to the downstream process.

Referring again to FIG. 1, the pellets are then supplied to a heating chamber (12) where they are heated to a temperature suitable to the polymer plus permeant system being treated. From the heating chamber the pellets are supplied to a vacuum chamber (13), which is evacuated to a pressure of 0.1 bar or less, more preferably 10⁻² bar or less, and most preferably 10⁻³ Torr or less. From the vacuum chamber, the pellets are passed to a doping chamber (14), where they are exposed to the permeant which is supplied via a manifold (15). From the manifold, the pellets are fed to a metering device (16) that directly feeds them to the throat of an extruder (17).

In a preferred embodiment of the process, the processes corresponding to steps 12, 13, and 14 in FIG. 1 are carried out in one container, which is one of at least a pair of containers and preferably three containers, which are indexed around a carousel. A piece of equipment of this type is manufactured by Maguire Products (Aston, Pa.).

The Maguire dryer operates with 3 Stainless Steel canisters that are mounted directly onto a carousel that indexes counterclockwise 360 degrees. Through this 3 step process each canister goes sequentially through 3 stages (which we also call “stations” in the following text) to dry materials.

In the first stage the canister is filled with material from the feeder (11). As the canister is being filled the heating process also begins. Heat can be applied by an electrical element or via any heat transfer medium known to one skilled in the art. Temperature can be controlled by a thermostat, and settings can be made easily by simply dialing in the required temperature on the thumbwheels of a controller, or by typing a temperature value in the corresponding field of a computer controlled device.

Once the canister has been heated for the time set it will then index automatically to the next stage, which is equivalent to station (13) of FIG. 1, where a vacuum is applied. At station 13, the canister is sealed and vacuum is applied, typically less than 0.1 bar, and preferably less than 10⁻² bar. Temperature is also controlled and may be different than in station (12). Moisture is evacuated to ambient air. A controller continuously monitors vacuum level ensuring the vacuum remains sufficient. The time that the canister is held under vacuum is also programmable.

After the vacuum cycle is completed the canister indexes again to the material treatment station. Under automatic operation a valve in the bottom of the canister is opened and material then flows from the canister into a material treatment chamber, indicated as 14 in FIG. 1 Chamber 14 is sealed to sustain positive pressure, preferably from 0.1 to 15 bar, and filled with gas at a given and controlled temperature, pressure, and composition, the gas or gases being fed in through manifold 15.

The exposure of the material in (14) lasts for a specific programmed time, after which it can be submitted to the exposure of the same or a second gas, under another set of specific temperature, time and pressure conditions. Following one or more exposures to gas, the material is released to the next step. In this next step the treated pellets are either stored in sealed bags for later use in a molding operation which will no longer require the presence of the drying/treatment equipment described above, or they are drawn by a feeder, for instance a vacuum loader or a starve-feeder screw device or any other feeding device known to the industry (all represented by 16 in FIG. 1) to the process machine, represented by 17 in FIG. 1. At the end of the cycle time the canister will index back to Stage 1.

In a further embodiment of the present invention, the chamber 14 is pressurized with a first gas, up to a required partial pressure and with another diluent gas to the total final pressure. In a still further embodiment of the invention, the pressure of the gas during the treatment in chamber 14, might be either maintained constant during the treatment, or varied according to a specific program, which can include vibratory or pulsatory changes in pressure. The program specifics would depend on the benefits obtained by testing empirically the effect of each process parameter. For example the effect of a fluctuation in pressure amplitude or frequency, on the diffusion of the gas into the free volume of the pellets.

In a preferred embodiment of the invention, the process is controlled by a system with a very simple to use operator interface, and preferably microprocessor based. For example, the dryer would be operated by simply setting the proper temperature and cycle time on the thumbwheels located to the right. The display will indicate temperature and elapsed cycle time or, alternatively, temperature and vacuum level. The controller monitors alarm conditions to ensure proper performance. As an aid to monitoring dryer performance and documenting operation a printer port is provided on the controller. A printed output of dryer operation may be obtained for each drying cycle.

An embodiment of the manifold (15) is shown in more detail in FIG. 2, in which parts (141), (142), (143) are conduits connecting to gas tanks (145) filled with the permeant, which can be a pure gas, a mix of gases and/or vapors, an aerosol, a fluidized bed, a liquified gas blended with some chemicals which vaporizes passing through injector nozzles (ultrasonic or otherwise), etc., and (144) are servo-valves, electronically controlled, connected to pressure regulators. The gas tanks could also be replaced by gas generators, such as N2 generators, capable of transforming regular air, sucked in from the ambient atmosphere, into pressurized and purified dry nitrogen. Although three sets of gas tanks and conduits are shown in FIG. 2, it is to be understood that as many should be present as are needed for the particular polymer plus permeant system that is being treated.

In another embodiment of the invention, one or more of the gas tanks could be an inert gas that acts as a carrier for some other permeant. For example in FIG. 2 is shown a chamber (146) integral with the conduit (143) into which can be sprayed at a controlled flow rate an aerosol, fine mist, or dust, that is to be carried into the manifold (15).

FIG. 3 shows an example of an embodiment of a configuration of a combined vacuum oven and dosing chamber of the invention (25), with vacuum setting and temperature both selectable, in which valves (23) open or close depending on whether the operator is setting up the vacuum connection to the vacuum pump, or inserting a gas A, or several gases A, B etc. Item (24) comprises an automatic feed mechanism with a flow controller, when the chamber is part of a continuous process, or a passageway to the manifold 22, in case of a batch process. The manifold comprises connections to the vacuum side, with 29 comprising a diffusion pump capable of going down to 10⁻² bar and preferably 10⁻⁴ bar. A and B comprise two sources of gas with permeant, which can be activated independently.

Item (26) comprises the material to be dried and treated according to the invention. Item (27) is the schematic for an electronically closing/opening valve gate which, at any programmed time, lets material (26) flow to chamber (28). Item (28) comprises either an area for the treated pellets to drop down to a sealed bag, or it is a compartment filled with a fluid containing a permeant that is able to penetrate inside the dried polymer when the pellets drop into it through opening of gate (27). In this embodiment, new material can be fed through a passage through (22) and (24) and a vacuum can be drawn by opening a valve (23) to the vacuum side. At the end of vacuum drying, either the gas A and/or B are activated, then followed by opening of valve gate (27), or an inert gas treatment is supplied to A alone (say pure N2) to return the chamber pressure to atmospheric pressure. (27) is then opened and the pellets are immersed into a static fluid resting at a certain temperature in (28). After a specific and controlled time, the soaked pellets are separated from the liquid, which is released from the chamber (28), and the pellets are carried away to either a bagging station, or for further treatment before they are bagged.

One skilled in the art would know how to vary the sequence of events described above, but still not vary from the spirit of the present invention. For instance, heaters for the vacuum oven could be replaced by RF heaters, or any dielectric means capable of rapidly raising the temperature of the plastic during the drying stage. Other means and types of vacuum pumps for obtaining a sufficient vacuum could be applied to the chamber in order to obtain a sufficient vacuum to operate the process. Similarly the invention is not to be construed to being limited to only two additives A and B.

A further embodiment of the process of the invention that uses the equipment configuration of FIG. 3 involves evacuating the chamber (25) and then allowing liquid with permeant and optionally solvent into the chamber (25) to the level of the pellets in the tray (26). Pellets are soaked for the required time and liquid is then drained from the vessel. The system can be optionally under an inert gas pressure during soaking, and the soaking process can optionally be repeated with a second and subsequent liquids.

The process of the invention can be scaled to fit in line with a polymer producing reactor. An example of this embodiment is shown schematically in FIG. 4. A reactor (31) feeds through a conduit (32) and flange (33), which can be a hopper, an extruder plus disentanglement unit (34) with polymer, which is pelletized in (35) and then conveyed to a series of operations (12, 13, 14, 15 and 16) that correspond to the items of the same number in FIG. 1, described above. Treated polymer is then fed to a bagging station (36) for storage and future processing. Alternatively the pellets from 16 can be fed to an on-line processing unit, for example extrusion, injection molding, blow molding or other processing operation known to one skilled in the art.

The equipment represented in FIG. 4 can be scaled to be attached at the end of a resin manufacturer's reactor and produce large scale quantity of “ready to use” treated resin, according to the claims of the present invention.

The possible embodiments of the invention are not intended to be limited by the description above of FIGS. 1 to 4. For example, the drying and permeation steps can be carried out in an extruder, instead of in the feed mechanism to an extruder. An example of a combination extruder plus dryer is that provided by the French Oil Mill Machinery Company (Piqua, Ohio) under the part number “R-176 extruder—dryer”. The R-176 uses a jacketed main barrel to carry a heat transfer fluid through to up to three separate control zones. In a modification of this machine that will be obvious to one skilled in the art, the zones can be used for drying and permeation of the pellets, before melting of the polymer takes place in a final zone.

All steps of the process can then be carried out sequentially on line in a conveying device, a modified extruder, which has sealed compartments. For example, in one embodiment could describe, the angle of the helicoidal flight flange could be adjustable from tilted (to convey forward) to straight perpendicular (to hold the pellets inside stationary at a given spot, to effect treatment of a certain kind for a certain time (like vacuum or heating or both, or permeation by a gas or a liquid). A software program would therefore direct the motion of the pellets from one station to the next, by triggering by a certain mechanism the change of the helicoidal angle, from straight to tilted, Or, if the conveying system is vertical, the screw can be rotating with no descending motion, only a stirring effect would be perceived, until the sealed trap separaing sections is opened, which would release to the next station, a given quantity of pellets ready for the next treatment.

The mechanism for heating the polymer need not be indirect, via a heat transfer medium, and radio frequency or microwave electromagnetic radiation could be used to heat the polymer directly.

### EXAMPLES

In the following examples, molecular weight measurements are performed using a Waters 150CV+ automated gel permeation chromatography (GPC) apparatus (Waters Inc., Milford, Mass.). For polyethylene terephthalate (PET) molecular weight measurement, a 2% solution of a freshly made mixture of HFIP/methyl Chloride (in proportion 1:9) is used to dissolve the samples and for the eluting fluid. A 0.2% w/v solution is prepared from the 2% solution and 20 □L injected @ 30° C. (column and pump are also set at 30° C.) at a flow rate of 0.5 ml/min with a pressure of 120-124 bars. A UV detector operating at 254 nm is used. For polycarbonate measurement, tetrahydrofuran (THF) is used as solvent, and a refractive index (RI) detector.

In examples 1 and 2 are demonstrated the use of carbon dioxide as a permeant to reduce the degree of molecular weight degradation that polyethylene terephthalate (PET) and polycarbonate (PC) respectively experience during melt processing.

### Example 1

Disentangled bottle grade PET of intrinsic viscosity (IV) 0.84 was subjected to gel permeation chromatography (GPC) and the following molecular weight distribution obtained;
Mn=8,298
Mw=26,780
Mz=50,090

The sample was dried at 90 C for 17.5 hours, and an MFI measurement was performed at 260 C. GPC was obtained on the extrudate from the MFI experiment. The following molecular weight distribution was obtained.
Mn=6,352
Mw=19,340
Mz=37,400

In a second trial, the experimental protocol above was repeated with the addition that the pellets were subjected after drying to carbon dioxide at 6 bar pressure for 30 minutes. The GPC data after the MFI experiment then showed a molecular weight distribution as follows;
Mn=7,498
Mw=23,540
Mz=44,460

These data show that processing the dried pellets without subjecting them to permeation by carbon dioxide according to the process of the present invention yields a 27.44% extent of chain degradation based on Mw. When the permeant is added the degradation extent is reduced to 12.1%.

### Example 2

A sample of polycarbonate with a Degree of disentanglement of 77% was dried at 65° C. for 17 hours. After MFI testing at 300° C. and 1.2 kg weight with no treatment with permeant, the M_{w} of the polymer, as measured by GPC, drops by 5%. A similarly dried sample is subjected to carbon dioxide at 1 bar pressure and after a similar MFI test the degree of degradation of Mw is in the range 2.1-2.5%.

Although the examples given above are limited to certain polymers and permeants, one skilled in the art could find other permeants and polymers to which to apply the process of the invention, and these are claimed herein. For example, the carbon dioxide permeant could be mixed with finely powdered phosphites or phosphites and/or phenols dissolved a solvent such as methyl chloride or cyclohexane and atomized by injection into the carbon dioxide. Other thermal stabilizers can be mixed with the carbon dioxide or another gas to improve stability during processing of the polymer.

### Example 3

In this example, polycarbonate resin in pellet form that is in a virgin state or disentangled is dried at 60° C. or 120° C. and optionally treated with water as 80% humidity air for 1 hour, or nitrogen gas at 1 bar for 4 hours. The MFI is measured at 300° C., 1.2 kg, in units of g/10 minutes. Tables 1 and 2 summarize the data.

TABLE 1
Virgin Polycarbonate

| Drying | Drying | Humidity | Nitrogen | |
|---|---|---|---|---|
| Time (Hours) | Temperature C. | for 1 hour | for 4 hours | MFI |
| 4 | 120 | No | No | 11.3 |
| 4 | 60 | Yes | no | 12.2 |
| 7 | 60 | No | no | 10.9 |
| 17 | 60 | No | no | 11.3 |
| 65 | 60 | No | no | 11.5 |
| 17 | 60 | No | yes | 11.6 |

TABLE 2
Disentangled Polycarbonate (77% Initial Disentanglement)

| Drying | | | | | % |
|---|---|---|---|---|---|
| Time | Drying | Humidity for | Nitrogen for | | chain |
| (Hours) | Temperature C. | 1 hour | 4 hours | MFI | scission |
| 4 | 120 | No | No | 20.1 | |
| 7 | 60 | No | No | 20.0 | |
| 17 | 60 | No | No | 20.1 | |
| 65 | 60 | No | No | 20.6 | |
| 17 | 60 | No | Yes | 29.6 | 3.3 |
| 17 | 60 | Yes | No | 65 | 23.0 |

From tables 1 and 2 can be seen that drying a disentangled sample and submitting it to either nitrogen gas at 1 bar pressure or humidified air at 1 bar pressure results in a change in both M_{w} and MFI. In the case of the nitrogen treated polymer, chain scission is minimal, but degree of disentanglement increases from 77% to 108% after correcting for the change in MFI.

### Example 4

In this example virgin and disentangled pellets were dried at 60 C for 17 hours, and optionally exposed to methanol vapor at 65 C for 1 hour. Melt flow was measured under a 1.2 kg weight at either 230 C or 300 C, and the degree of disentanglement and % chain scission was measured.

TABLE 3
Virgin Resin

| | MFI | MFI | | |
|---|---|---|---|---|
| | Temperature | Measured | Chain | Degree of |
| Methanol | (° C.) | g/10 min | Scission % | Disentanglement |
| No | 230 | 0.6 | 1.5 | 0 |
| No | 300 | 11.3 | 0.9 | 0 |
| Yes | 230 | 1.1 | 11.5 | 0 |
| Yes | 300 | 13.5 | 2.8 | 8.5 |

TABLE 4
Initial Degree of Disentanglement 77%

| | MFI | MFI | Chain | Degree of |
|---|---|---|---|---|
| Methanol | Temperature | Measured | Scission | Disentanglement |
| Yes | 230 | 10.3 | 34.6 | 305 |
| Yes | 300 | 286 | 51.1 | 122 |

Table 4 shows that although more chain scission occurs at higher temperature, the degree of disentanglement, when corrected for chain scission, is significantly higher at the lower processing temperature. The data indicate the ability of the process of the invention to produce lower viscosity resins than would be possible by simple chain scission types of mechanisms.

### Example 5

Disentangled polycarbonate pellets (Degree of disentanglement=77%) were subjected to the following treatment. Pellets were dried at 65° C. for 17 hours and then treated with a gas mixture at 65° C. and a pressure of 2 bar. The gas mixture contained methanol at a partial pressure of 0.75 bar, applied first, and nitrogen at a partial pressure for 1.25 bar. Melt index was determined at 300° C., and the final melt index was 412, with a % chain scission of 64.65% and Degree of disentanglement of 6.2%.

Example 5 shows that the effect of substantial reduction in Mw (which in this case went to 8,400, very close to the entanglement molecular weight of polycarbonate, which is 5,500) was to remove the disentanglement of the chains. The process of the invention in this example provides a means for reducing molecular weight of the polymer.

### Example 6

Disentangled and virgin polycarbonate pellets (initial M_{w}>23,000) were dried at 85° C. overnight. They were subjected to a treatment with methyl alcohol with the partial pressure of methyl alcohol as given in table 3, and the remaining pressure adjusted up to a total of 1 bar total with nitrogen.

TABLE 5
Disentangled Polycarbonate

| Partial Pressure of | | Degree of |
|---|---|---|
| Methyl Alcohol (bar) | % Chain Scission | Disentanglement |
| 0 | 16.87 | 27.48 |
| 0.05 | 29.29 | 9.75 |
| 0.10 | 38.30 | 26.82 |
| 0.25 | 45.56 | 65.78 |
| 0.40 | 53.92 | 72.73 |

TABLE 6
Virgin Polycarbonate

| Partial Pressure of | | Degree of |
|---|---|---|
| Methyl Alcohol (bar) | % Chain Scission | Disentanglement |
| 0 | 0.00 | 0.00 |
| 0.05 | 2.80 | 0.00 |
| 0.10 | 4.10 | 0.00 |
| 0.25 | 4.49 | 0.00 |
| 0.40 | 4.65 | 0.00 |

Tables 5 and 6 demonstrate that previously disentangled polymer is affected much more by the permeant with higher levels of chain scission and degree of disentanglement than the virgin polymer, which undergoes no disentanglement.

### Example 7

Virgin polymethylmethacrylate (PMMA) pellets of M_{w} 114,000 Daltons was dried at 60° C. for 17 hours. The melt flow index (MFI) at 235° C., 8.16 kg was 11.0. The dried pellets were subjected to the process of the invention by exposure to the following steps;

Vacuum at 10⁻⁴ bar at 35° C., followed by soaking in a mixture of 5% stearic acid in methanol for 1 hour at 35° C. under 1 atmosphere pressure. The pellets were dried again at 60 C for 17 hours and the MFI test rerun. MFI was 29.5, with % chain broken=0.8% and % disentanglement=160%.

The same virgin PMMA polymer was then subjected to disentanglement in a TekFlow processor. With no degradation the MFI went to 12.9 and % disentanglement was 17.3%.

The disentangled PMMA sample was subjected to the same treatment as above with strearic acid in methanol. MFI was 61.6, with % chain broken=0% and % disentanglement=426%.

### Example 8

A virgin linear low density polyethylene (Engage 8180, Dupont Dow Elastomers) of M_{w}=165,100 had an MFI of 14.2 grams per 10 minutes at 190° C. and 21.6 kg. Pellets were treated according to the process of the invention embodied in FIG. 3. The pellets were subjected to a vacuum of 1 ₀₄ bar at 25° C. They were soaked for one hour at 25 C in a mixture of white spirit and ethanol into which 5% total of fatty acid esters were dissolved. The pellets were dried under vacuum for one hour and blown with air for 7 hours.

Final MFI was 16.6, with no chain breakage and % disentanglement of 16.9%.

Disentangled pellets of the LLDPE treated in a TekFlow processor had an MFI of 19.2 with essentially zero chain breakage and 35% disentanglement. When the disentangled pellets were treated with fatty acid esters in the same way as above, MFI of the product was 49.2 g per 10 minues, with 2.2% chain breakage and 214% disentanglement.

The virgin LLDPE was finally treated in a TekFlow processor to 35% disentanglement and subjected to the same soaking in fatty acid ester solution. Pellets were retreated in a TekFlow processor and the MFI of the resulting pellets was 165.4, % chain breakage was 10.2% and disentanglement was 712%.

### Example 9

A virgin polycarbonate had a melt flow of 58, with a Mw of 14,500. It was subjected to the treatment of the invention by drying at 60° C. under a vacuum of 10⁻⁴ bar for 17 hours. It was then soaked in water at 55° C. for 2 hours at atmospheric pressure. Pellets were surface dried in paper towels and the water content measured as 0.415%.

The pellets were then disentangled in a TekFlow processor, which yielded a product with a melt flow of 117, negligible chain breakage and a degree of disentanglement of 100%.

The disentangled pellets were subjected to water at 55° C. and for one hour as above, and the measured moisture content of the pellets was 1.15%.

### Example 10

The virgin polycarbonate of example 9 was subjected to water treatment at 55° C. and 4 atmospheres pressure, applied with nitrogen. The moisture content of the pellets was 2.9%.

### Example 11

The virgin polycarbonate of example 9 was subjected to water treatment at 55° C. and 7 atmospheres pressure, applied with nitrogen. The moisture content of the pellets was 3.12%.

### Example 12

The virgin polycarbonate of example 9 was subjected to water treatment at 65° C. and 7 atmospheres pressure, applied with nitrogen. The moisture content of the pellets was 4.6%.

The examples described above show the effectiveness of the present invention in lowering viscosity of polymer melts. The virgin pellets treated according to the process of the invention show increase in melt flow index. Starting from already disentangled pellets, the melt flow increase is substantially higher, and maximum increase in melt flow comes from subsequent processing of treated pellets in a disentanglement step.

In summary, the embodiments exemplified here show the ability of the process of the invention to alter and control the rheological properties of a polymer by impregnating solid polymer with a relatively small amount of permeant, the effect being increased when the polymer is disentangled.

### OTHER EMBODIMENTS

In the embodiments of the examples described above the permeant is introduced in one stage to the polymer. However, in alternative embodiments, the permeant is introduced in two stages. For example in a first stage, the permeant is introduced at a pressure in the preferred range of range of 0.1 bar to 20 bar, and in a second stage at a different pressure or the same pressure than the first stage. For example, in one embodiment the second stage is at a lower pressure than the first stage. In another embodiment, the second stage is at a higher pressure than the first stage. The invention is not to be construed as limited to these examples, however, and one skilled in the art will be able to perceive of alternative ways of introducing permeant to polymer that are to be considered as falling within the scope of the present invention.

In yet another embodiment, at one stage the permeant contains a chemical component that is capable of breaking polymer chains, such as for example water or methyl alcohol in the case of polymers made by condensation reactions, and in a second stage the permeant contains a polymer chain building reagent, such as a cross linking agent or branching agent, or cyclic monomers, such as cyclic butylene terephthalate (CBT), capable of very fast ring opening and local chain growth.

The conditions under which the process of the invention is operated, such as pressures, temperatures, concentrations, and reaction times, are determined as a function of the objectives that the operator or polymer fabricator wishes to accomplish. The present invention gives the fabricator the possibility to tailor the properties and in particular the processability of the resin at will.

The invention is also not intended to be limited as to the nature of the permeants or polymers that can be processed thereby, and any polymeric molecule that can be disentangled can be used in the invention. For example; ethylene propylene copolymer, high-density polyethylene, high-impact polystyrene, low-density polyethylene, polyamide, polyacrylic acid, polyamide-imide, polyacrylonitrile, polyarylsulfone, polybutylene, polybutadiene acrylonitrile, polybutadiene styrene, polybutadiene terephthalate, polycarbonate, polycaprolactone, polyethylene, polyethyl acrylate, polyetheredierketone, polyethylene sulfone, polyethylene terephthalate, polyethylene terephthalate glycol, polyimide, polyisobutylene, polymethyl acrylate, polymethyl ethyl acrylate, polymethyl methacrylate, polyoxymethylene (polyacetal), polyphenylene ether, polyphenylene oxide, polyphenylene sulfide, polypropylene terephthalate, polystyrene, polytetrafluoroethylene, polyurethane, polyvinyl alcohol, polyvinyl acetate, polyvinyl chloride, polyvinylidene chloride, polyvinylidene fluoride, polyvinyl methyl ether, polyvinyl methyl ketone, styrene butadiene, styrene butadiene rubber, cellulose acetate, cellulose acetate butyrate, cellulose acetate propionate, cellulose nitrate, chlorinated polyethylene, chlorotrifluoroethlylene, ethylene acrylic acid, ethylene butyl acrylate, ethyl cellulose, and polymers and copolymers of acrylonitrile butadiene acrylate, acrylonitrile butadiene styrene, acrylonitrile, chlorinated PE and styrene, acrylonitrile methyl methacrylate, acrylonitrile, actylonitrile styrene, acrylonitrile, butadiene acrylonitrile, ethylene propylene diene monomer, and blends or copolymers of the preceding.

1.) A method for controlling the molecular weight of a polymer by permeating the polymer with a permeant while the polymer has a degree of entanglement greater than about 2% and is in the solid state, and subjecting the polymer plus permeant blend to a melt processing operation.

2.) The method of claim 1 in which the polymer is selected from the group consisting of ethylene propylene copolymer, high-density polyethylene, high-impact polystyrene, low-density polyethylene, polyamide, polyacrylic acid, polyamide-imide, polyacrylonitrile, polyarylsulfone, polybutylene, polybutadiene acrylonitrile, polybutadiene styrene, polybutadiene terephthalate, polycarbonate, polycaprolactone, polyethylene, polyethyl acrylate, polyetheredierketone, polyethylene sulfone, polyethylene terephthalate, polyethylene terephthalate glycol, polyimide, polyisobutylene, polymethyl acrylate, polymethyl ethyl acrylate, polymethyl methacrylate, polyoxymethylene (polyacetal), polyphenylene ether, polyphenylene oxide, polyphenylene sulfide, polypropylene terephthalate, polystyrene, polytetrafluoroethylene, polyurethane, polyvinyl alcohol, polyvinyl acetate, polyvinyl chloride, polyvinylidene chloride, polyvinylidene fluoride, polyvinyl methyl ether, polyvinyl methyl ketone, styrene butadiene, styrene butadiene rubber, cellulose acetate, cellulose acetate butyrate, cellulose acetate propionate, cellulose nitrate, chlorinated polyethylene, chlorotrifluoroethlylene, ethylene acrylic acid, ethylene butyl acrylate, ethyl cellulose, and polymers and copolymers of acrylonitrile butadiene acrylate, acrylonitrile butadiene styrene, acrylonitrile, chlorinated PE and styrene, acrylonitrile methyl methacrylate, acrylonitrile, actylonitrile styrene, acrylonitrile, butadiene acrylonitrile, ethylene propylene diene monomer, and blends or copolymers of the preceding.

3.) The method of claim 1 in which the permeant is selected from the group consisting of; carbon dioxide, nitrogen, oxygen, hydrogen, helium, argon, neon, nitrous oxide, nitric oxide, water, dicumyl peroxide, butyl cumyl peroxide, di-t-butyl peroxide, dimethyl di-t-butyl-peroxyhexane, bis(t-butylperoxy)-di-isopropylbenzene, ethylene glycol dimethacrylate, butylene glycol dimethacrylate, diallyl terephthalate, triallyl isocyanurate, trimethylol propane trimethacrylate, m-phenylene-dimaleimide, pentane, maleic anhydride, silyl peroxide, aluminum trichloride, p-Xylene, trichlorobenzene, toluene, and blends or combinations of the preceding.

4.) The method of claim 1 in which the permeant is selected from a group that is a member of the group consisting of; silanes, siloxanes, polyesters, halogenated monomers, titanates, acid anhydrides, Lewis acid inorganic, aliphatic monocarboxylic acid esters, aromatic monocarboxylic acids, aliphatic dicarboxylic acid esters, phosphates, polyester or polymeric plasticizers, phenols and amines, phosphates, sulfur containing stabilizers, hindered amine light stabilizers. hydroxyphenylpropionates, hydroxybenzyl compounds, alkylidene bisphenols, secondary aromatic amines, thiobisphenols, aminophenols, thiothers, phosphates and phosphonites, metal deactivators, amides of aliphatic and aromatic mono and dicarboxylic acids and their N-monosubstituted derivatives, cyclic amides, hydrazones, bishydrazones of aliphatic and aromatic aldehydes, bis acylated hydrazine derivatives, benzotriazoles, 8-oxyquinoline, hydrazones, acylated derivatives of hydrazinotriazines, aminotriazaoles and acylated derivatives thereof, polyhydrazides, nickel salts of benzyl phosphonic acids, alone, or in combination with other antioxidants or metal deactivators, pyridenethiol tin compounds, phosphorous acid esters of a thiobisphenol and blends or combinations of the preceding.

5.) The method of claim 1 in which the permeant is a solvent for the polymer.

6.) The method of claim 1 in which the permeant is selected from a group consisting of an alkane, an alkene, an alcohol, an ether, an ester, a chlorofluorocarbon, and any blends or combinations of any of the preceding.

7.) The method of claim 1 in which the permeant is cyclic butylene terephthalate and the polymer is polycarbonate or a polyester.

8.) The method of claim 1 in which the polymer has been subjected to processing in a Tek Flow processor before the permeation step.

9.) A method for obtaining a polymer of a desired molecular weight and viscosity, comprising the following steps;
i. providing a polymer in the solid state in which the solid polymer has a degree of disentanglement greater than about 2%,
ii. providing a permeant,
iii. drying the polymer to an effective level of moisture, and
iv. contacting the dried polymer with the permeant for a controlled time and at a controlled temperature and pressure.

10) The method of claim 9 which further comprises the step of subjecting the polymer plus permeant to a melt processing operation during which the polymer is melted and the melted polymer is subjected to shear and pressure, in which method the combination of melt processing temperature, melt processing shear rate, duration of melt processing, level of drying and time, temperature, and pressure of exposure to permeant and the nature of the polymer and permeant are such that a desired combination of molecular weight and viscosity are obtained.

11.) The method of claim 9 in which the polymer is selected from the group consisting of ethylene propylene copolymer, high-density polyethylene, high-impact polystyrene, low-density polyethylene, polyamide, polyacrylic acid, polyamide-imide, polyacrylonitrile, polyarylsulfone, polybutylene, polybutadiene acrylonitrile, polybutadiene styrene, polybutadiene terephthalate, polycarbonate, polycaprolactone, polyethylene, polyethyl acrylate, polyetheredierketone, polyethylene sulfone, polyethylene terephthalate, polyethylene terephthalate glycol, polyimide, polyisobutylene, polymethyl acrylate, polymethyl ethyl acrylate, polymethyl methacrylate, polyoxymethylene (polyacetal), polyphenylene ether, polyphenylene oxide, polyphenylene sulfide, polypropylene terephthalate, polystyrene, polytetrafluoroethylene, polyurethane, polyvinyl alcohol, polyvinyl acetate, polyvinyl chloride, polyvinylidene chloride, polyvinylidene fluoride, polyvinyl methyl ether, polyvinyl methyl ketone, styrene butadiene, styrene butadiene rubber, cellulose acetate, cellulose acetate butyrate, cellulose acetate propionate, cellulose nitrate, chlorinated polyethylene, chlorotrifluoroethlylene, ethylene acrylic acid, ethylene butyl acrylate, ethyl cellulose, and polymers and copolymers of acrylonitrile butadiene acrylate, acrylonitrile butadiene styrene, acrylonitrile, chlorinated PE and styrene, acrylonitrile methyl methacrylate, acrylonitrile, actylonitrile styrene, acrylonitrile, butadiene acrylonitrile, ethylene propylene diene monomer, and blends or copolymers of the preceding.

12.) The method of claim 9 in which the permeant is selected from the group consisting of; carbon dioxide, nitrogen, oxygen, hydrogen, helium, argon, neon, nitrous oxide, nitric oxide, water, dicumyl peroxide, butyl cumyl peroxide, di-t-butyl peroxide, dimethyl di-t-butyl-peroxyhexane, bis(t-butylperoxy)-di-isopropylbenzene, ethylene glycol dimethacrylate, butylene glycol dimethacrylate, diallyl terephthalate, triallyl isocyanurate, trimethylol propane trimethacrylate, m-phenylene-dimaleimide, pentane, maleic anhydride, silyl peroxide, aluminum trichloride, p-Xylene, trichlorobenzene, toluene, and blends or combinations of the preceding.

13.) The method of claim 9 in which the permeant is selected from a group that is a member of the group consisting of; silanes, siloxanes, polyesters, halogenated monomers, titanates, acid anhydrides, Lewis acid inorganic, aliphatic monocarboxylic acid esters, aromatic monocarboxylic acids, aliphatic dicarboxylic acid esters, phosphates, polyester or polymeric plasticizers, phenols and amines, phosphates, sulfur containing stabilizers, hindered amine light stabilizers. hydroxyphenylpropionates, hydroxybenzyl compounds, alkylidene bisphenols, secondary aromatic amines, thiobisphenols, aminophenols, thiothers, phosphates and phosphonites, metal deactivators, amides of aliphatic and aromatic mono and dicarboxylic acids and their N-monosubstituted derivatives, cyclic amides, hydrazones, bishydrazones of aliphatic and aromatic aldehydes, bis acylated hydrazine derivatives, benzotriazoles, 8-oxyquinoline, hydrazones, acylated derivatives of hydrazinotriazines, aminotriazaoles and acylated derivatives thereof, polyhydrazides, nickel salts of benzyl phosphonic acids, alone, or in combination with other antioxidants or metal deactivators, pyridenethiol tin compounds, phosphorous acid esters of a thiobisphenol and blends or combinations of the preceding.

14.) The method of claim 9 in which the permeant is a solvent for the polymer.

15.) The method of claim 9 in which the permeant is selected from a group consisting of an alkane, an alkene, an alcohol, an ether, an ester, a chlorofluorocarbon, and any blends or combinations of any of the preceding.

16.) The method of claim 9 in which the permeant is cyclic butylene terephthalate and the polymer is polycarbonate or a polyester.

17.) The method of claim 9 in which the controlled temperature is obtained by subjecting the polymer to microwave radiation or radio frequency radiation.

18.) The method of claim 9 in which the solid polymer is in the form of pellets, and during step (iii) or step (iv), or both, the pellets are either subjected to a means for agitation by a rotating blade, or is subjected to vibratory motion.

19.) The method of claim 9 in which the steps (iii) and (iv) are carried out on a rotating carousel, said carousel comprising two or more containers that are rotated in order to carry out the operations of the method in sequence.

20.) The method of claim 9 in which the steps (iii) and (iv) are carried out in the same extruder barrel as is the melt processing operation.

21.) The method of claim 9 in which the polymer has been subjected to processing in a Tek Flow processor before being contacted with the permeant.

22.) A product made by the process of controlling the molecular weight of a polymer by permeating the polymer with a permeant while the polymer has a degree of entanglement greater than about 2% and is in the solid state, and subjecting the polymer plus permeant blend to a melt processing operation.

23.) A product made by the process of obtaining a polymer of a desired molecular weight and viscosity, comprising the following steps;
i. providing a polymer in the solid state and which has a degree of disentanglement greater than zero,
ii. providing a permeant,
iii. drying the polymer to an effective level of moisture,
iv. contacting the dried polymer with the permeant for a controlled time and at a controlled temperature and pressure,

24) A product made by the process of claim 23 with the additional step of subjecting the polymer plus permeant to a melt processing operation during which the polymer is melted and the melted polymer is subjected to shear and pressure, in which method the combination of melt processing temperature, melt processing shear rate, duration of melt processing, level of drying and time and temperature and pressure of exposure to permeant and the nature of the polymer and permeant are such that the desired combination of molecular weight and viscosity are obtained.

25.) The product of claim 22 or 23 in which the polymer has been subjected to processing in a Tek Flow processor in order to induce the state of having a degree of disentanglement greater than zero.

26.) A method for labeling a polymer that comprises the steps of
i. disentangling the polymer to a degree of entanglement greater than zero,
ii. drying the disentangled polymer,
iii. exposing the material to a permeant that is allowed to diffuse into the polymer,
where said permeant is selected from the group consisting of a fluorescent material, a phosphorescent material, a spin labeled material, a material that can be characterized spectroscopically by an infra red absorption band, and a material that can be characterized by a spectroscopic technique other than infra red absorption.

27.) A labeled polymer made by the process that comprises the steps of
i. disentangling the polymer to a degree of disentanglement greater than zero,
ii. drying the disentangled polymer,
iii. exposing the material to a permeant that is allowed to diffuse into the polymer,
where said permeant is selected from the group consisting of a fluorescent material, a phosphorescent material, a spin labeled material, a material that can be characterized spectroscopically by an infra red absorption band, and a material that can be characterized by a spectroscopic technique other than infra red absorption.

28.) A method for modifying the magnetic or dielectric properties of a polymer that comprises the steps of
i. disentangling the polymer to a degree of entanglement greater than zero,
ii. drying the disentangled polymer,
iii. exposing the material to a permeant that is allowed to diffuse into the polymer,
where said permeant is selected from the group consisting of an ionic material, a magnetically polarized material and a plasma.

29.) A product made by the process that comprises the steps of
i. disentangling the polymer to a degree of disentanglement greater than zero,
ii. drying the disentangled polymer,
iii. exposing the material to a permeant that is allowed to diffuse into the polymer,
where said permeant is selected from the group consisting of an ionic material, a magnetically polarized material and a plasma.

30.) The product of claim 26, 27, 28 or 29 in which the step of disentangling the polymer is carried out in a Tek Flow processor.

31.) A method for controlling the molecular weight of a polymer by permeating the polymer with a permeant while the polymer is in the solid state and has a degree of disentanglement of essentially zero, and subjecting the polymer plus permeant blend to a melt processing operation.

32.) The method of claim 31 in which the polymer is selected from the group consisting of ethylene propylene copolymer, high-density polyethylene, high-impact polystyrene, low-density polyethylene, polyamide, polyacrylic acid, polyamide-imide, polyacrylonitrile, polyarylsulfone, polybutylene, polybutadiene acrylonitrile, polybutadiene styrene, polybutadiene terephthalate, polycarbonate, polycaprolactone, polyethylene, polyethyl acrylate, polyetheredierketone, polyethylene sulfone, polyethylene terephthalate, polyethylene terephthalate glycol, polyimide, polyisobutylene, polymethyl acrylate, polymethyl ethyl acrylate, polymethyl methacrylate, polyoxymethylene (polyacetal), polyphenylene ether, polyphenylene oxide, polyphenylene sulfide, polypropylene terephthalate, polystyrene, polytetrafluoroethylene, polyurethane, polyvinyl alcohol, polyvinyl acetate, polyvinyl chloride, polyvinylidene chloride, polyvinylidene fluoride, polyvinyl methyl ether, polyvinyl methyl ketone, styrene butadiene, styrene butadiene rubber, cellulose acetate, cellulose acetate butyrate, cellulose acetate propionate, cellulose nitrate, chlorinated polyethylene, chlorotrifluoroethlylene, ethylene acrylic acid, ethylene butyl acrylate, ethyl cellulose, and polymers and copolymers of acrylonitrile butadiene acrylate, acrylonitrile butadiene styrene, acrylonitrile, chlorinated PE and styrene, acrylonitrile methyl methacrylate, acrylonitrile, actylonitrile styrene, acrylonitrile, butadiene acrylonitrile, ethylene propylene diene monomer, and blends or copolymers of the preceding.

33.) The method of claim 31 in which the permeant is selected from the group consisting of; carbon dioxide, nitrogen, oxygen, hydrogen, helium, argon, neon, nitrous oxide, nitric oxide, water, dicumyl peroxide, butyl cumyl peroxide, di-t-butyl peroxide, dimethyl di-t-butyl-peroxyhexane, bis(t-butylperoxy)-di-isopropylbenzene, ethylene glycol dimethacrylate, butylene glycol dimethacrylate, diallyl terephthalate, triallyl isocyanurate, trimethylol propane trimethacrylate, m-phenylene-dimaleimide, pentane, maleic anhydride, silyl peroxide, aluminum trichloride, p-Xylene, trichlorobenzene, toluene, and blends or combinations of the above.

34.) The method of claim 31 in which the permeant is selected from a group that is a member of the group consisting of; silanes, siloxanes, polyesters, halogenated monomers, titanates, acid anhydrides, Lewis acid inorganic, aliphatic monocarboxylic acid esters, aromatic monocarboxylic acids, aliphatic dicarboxylic acid esters, phosphates, polyester or polymeric plasticizers, phenols and amines, phosphates, sulfur containing stabilizers, hindered amine light stabilizers. hydroxyphenylpropionates, hydroxybenzyl compounds, alkylidene bisphenols, secondary aromatic amines, thiobisphenols, aminophenols, thiothers, phosphates and phosphonites, metal deactivators, amides of aliphatic and aromatic mono and dicarboxylic acids and their N-monosubstituted derivatives, cyclic amides, hydrazones, bishydrazones of aliphatic and aromatic aldehydes, bis acylated hydrazine derivatives, benzotriazoles, 8-oxyquinoline, hydrazones, acylated derivatives of hydrazinotriazines, aminotriazaoles and acylated derivatives thereof, polyhydrazides, nickel salts of benzyl phosphonic acids, alone, or in combination with other antioxidants or metal deactivators, pyridenethiol tin compounds, phosphorous acid esters of a thiobisphenol and blends or combinations of the above.

35.) The method of claim 31 in which the permeant is a solvent for the polymer.

36.) The method of claim 31 in which the permeant is selected from a group consisting of an alkane, an alkene, an alcohol, an ether, a chlorofluorocarbon, and any blends or combinations of any of the preceding.

37.) The method of claim 31 in which the permeant is cyclic butylene terephthalate and the polymer is polycarbonate or a polyester.

38.) A method for controlling the molecular weight of a polymer in which a polymer of a desired molecular weight and viscosity is obtained, the method comprising the following steps;
i. providing a solid polymer that has a degree of disentanglement of essentially zero,
ii. providing a permeant,
iii. drying the polymer to an effective level of moisture,
iv. permeating the polymer by contacting the dried polymer with the permeant for a controlled time and at a controlled temperature and pressure,
v. subjecting the polymer plus permeant to a melt processing operation during which the polymer is melted and the melted polymer is subjected to shear,
in which method the combination of melt processing temperature, melt processing shear rate, duration of melt processing, level of drying and time of exposure to drying, time, temperature and pressure of exposure to permeant and the nature of the polymer and permeant are such that the desired combination of molecular weight and viscosity are obtained.

39.) The method of claim 38 in which the polymer is selected from the group consisting of ethylene propylene copolymer, high-density polyethylene, high-impact polystyrene, low-density polyethylene, polyamide, polyacrylic acid, polyamide-imide, polyacrylonitrile, polyarylsulfone, polybutylene, polybutadiene acrylonitrile, polybutadiene styrene, polybutadiene terephthalate, polycarbonate, polycaprolactone, polyethylene, polyethyl acrylate, polyetheredierketone, polyethylene sulfone, polyethylene terephthalate, polyethylene terephthalate glycol, polyimide, polyisobutylene, polymethyl acrylate, polymethyl ethyl acrylate, polymethyl methacrylate, polyoxymethylene (polyacetal), polyphenylene ether, polyphenylene oxide, polyphenylene sulfide, polypropylene terephthalate, polystyrene, polytetrafluoroethylene, polyurethane, polyvinyl alcohol, polyvinyl acetate, polyvinyl chloride, polyvinylidene chloride, polyvinylidene fluoride, polyvinyl methyl ether, polyvinyl methyl ketone, styrene butadiene, styrene butadiene rubber, cellulose acetate, cellulose acetate butyrate, cellulose acetate propionate, cellulose nitrate, chlorinated polyethylene, chlorotrifluoroethlylene, ethylene acrylic acid, ethylene butyl acrylate, ethyl cellulose, and polymers and copolymers of acrylonitrile butadiene acrylate, acrylonitrile butadiene styrene, acrylonitrile, chlorinated PE and styrene, acrylonitrile methyl methacrylate, acrylonitrile, actylonitrile styrene, acrylonitrile, butadiene acrylonitrile, ethylene propylene diene monomer, and blends or copolymers of the preceding.

40.) The method of claim 38 in which the permeant is selected from the group consisting of; carbon dioxide, nitrogen, oxygen, hydrogen, helium, argon, neon, nitrous oxide, nitric oxide, water, dicumyl peroxide, butyl cumyl peroxide, di-t-butyl peroxide, dimethyl di-t-butyl-peroxyhexane, bis(t-butylperoxy)-di-isopropylbenzene, ethylene glycol dimethacrylate, butylene glycol dimethacrylate, diallyl terephthalate, triallyl isocyanurate, trimethylol propane trimethacrylate, m-phenylene-dimaleimide, pentane, maleic anhydride, silyl peroxide, aluminum trichloride, p-Xylene, trichlorobenzene, toluene, and blends or combinations of the above.

41.) The method of claim 38 in which the permeant is selected from a group that is a member of the group consisting of; silanes, siloxanes, polyesters, halogenated monomers, titanates, acid anhydrides, Lewis acid inorganic, aliphatic monocarboxylic acid esters, aromatic monocarboxylic acids, aliphatic dicarboxylic acid esters, phosphates, polyester or polymeric plasticizers, phenols and amines, phosphates, sulfur containing stabilizers, hindered amine light stabilizers. hydroxyphenylpropionates, hydroxybenzyl compounds, alkylidene bisphenols, secondary aromatic amines, thiobisphenols, aminophenols, thiothers, phosphates and phosphonites, metal deactivators, amides of aliphatic and aromatic mono and dicarboxylic acids and their N-monosubstituted derivatives, cyclic amides, hydrazones, bishydrazones of aliphatic and aromatic aldehydes, bis acylated hydrazine derivatives, benzotriazoles, 8-oxyquinoline, hydrazones, acylated derivatives of hydrazinotriazines, aminotriazaoles and acylated derivatives thereof, polyhydrazides, nickel salts of benzyl phosphonic acids, alone, or in combination with other antioxidants or metal deactivators, pyridenethiol tin compounds, phosphorous acid esters of a thiobisphenol and blends or combinations of the above.

42.) The method of claim 38 in which the permeant is a solvent for the polymer.

43.) The method of claim 38 in which the permeant is selected from a group consisting of an alkane, an alkene, an alcohol, an ether, a chlorofluorocarbon, and any blends or combinations of any of the preceding.

44.) The method of claim 38 in which the permeant is cyclic butylene terephthalate and the polymer is polycarbonate or a polyester.

45.) The method of claim 38 in which the controlled temperature is obtained by subjecting the polymer to microwave radiation or radio frequency radiation.

46.) The method of claim 38 in which the polymer is in the form of pellets, and during the steps of being subjected to a vacuum, or contact with the permeant, the pellets are either subjected to a means for agitation by a rotating blade, or is subjected to vibratory motion.

47.) The method of claim 38 in which the steps of drying and permeation are carried out on a rotating carousel, said carousel comprising two or more containers that are rotated in order to carry out the operations of the method in sequence.

48.) The method of claim 38 in which the steps of drying the polymer and contacting the dried polymer with a permeant are carried out in the same extruder barrel as is the melt processing operation.

49.) A product made by the process of controlling the molecular weight of a polymer by permeating the polymer with a substance while the polymer is in the solid state and has a degree of disentanglement of zero, and subjecting the polymer plus permeant blend to a melt processing operation.

50.) A product made by the process of obtaining a polymer of a desired molecular weight and viscosity, comprising the following steps;
v. providing a solid polymer which has a degree of disentanglement of essentially zero,
vi. providing a permeant,
vii. drying the polymer to an effective level of moisture,
viii. contacting the dried polymer with the permeant for a controlled time and at a controlled temperature and pressure,
ix. subjecting the polymer plus permeant to a melt processing operation during which the polymer is melted and the melted polymer is subjected to shear,
in which method the combination of melt processing temperature, melt processing shear rate, duration of melt processing, level of drying and time, pressure and temperature of exposure to permeant and the nature of the polymer and permeant are such that the desired combination of molecular weight and viscosity are obtained.
